(19) United States
(12) Patent Application Publication
(10) Pub. No.: US 2009/0216726 A1
(43) Pub. Date: Aug. 27, 2009

(54) System and Method for Facilitating Business Communications

(76) Inventors: Ramachandran Muthaiah, Cupertino, CA (US); Suguna Vepa, Pleasanton, CA (US)

Correspondence Address: BAKER BOTTS L.L.P., 2001 ROSS AVENUE, SUITE 600, DALLAS, TX, 75201-2980, US

(21) Appl. No.: 12/390,007

(22) Filed: Feb. 20, 2009

Related U.S. Application Data
(60) Provisional application No. 61/030,715, filed on Feb. 22, 2008.

(51) Int. Cl. G06F 17/30

(52) U.S. Cl. 707/3; 707/104.1; 705/30; 707/E17.014; 707/E17.044

(57) ABSTRACT

A system and method for facilitating business communications are disclosed. The method may include receiving a plurality of business transaction records from an accounting module; each business transaction record including an amount and a date. The method may also include providing a customer user interface configured to allow a first customer user, associated with a first customer, to search and access a first customer accessible subset of the plurality of unpaid business transaction records, the first customer accessible subset including only business transaction records associated with the first customer, and to participate in a first communication dialog, the dialog associated with one or more of the business transaction records in the first customer accessible subset. The method may further include providing an accounting user interface configured to allow the first accounting user to search and access an accounting accessible subset of the plurality of unpaid business transaction records, the accounting accessible subset including the first customer accessible subset, and participate in the first communication dialog.

### RELATED APPLICATION

This application claims the benefit of U.S. Provisional Patent Application Ser. No. 61/030,715 entitled “System and Method for Facilitating Business Communications” filed Feb. 22, 2008. The contents of this application is incorporated herein in its entirety by this reference.

### TECHNICAL FIELD

The present invention relates generally to business communications and, more particularly, to a system and method for facilitating business communications.

### BACKGROUND

Timely collection of accounts receivable is important in most any organization. Issues may arise in conjunction with various forms of documentation including invoices, credit memos, purchase orders, debit memos, proof of delivery, etc. When these issues are addressed quickly, receivables turn into cash, reducing the Days Sales Outstanding (DSO) and eliminating bad debt. However, problems may arise when management of receivables and communication with customers falter. Data may be lost because e-mails with customers about outstanding invoices may be scattered about the enterprise or the information exchange process may be incomplete. Because of these an other deficiencies, progress towards timely collection slows, and receivables age. When this happens, valuable cash may be tied up and compliance with regulatory schemes may be jeopardized.

Some basic accounting terminology may be helpful for understanding the present disclosure. Many customers purchase goods and services on credit extended by the seller. This may be short term credit payable within, for example, 15 days (Net 15) or 30 days (Net 30) after the goods were delivered or the services were rendered (the “delivery date”). Accounts receivable (AR) are the accounts of money owed to the seller/provider (the “AR company”) by the customer (the “AP company”). A customer may keep a mirror image account in its accounting system called an accounts payable (AP). The age of an AR is typically the number of days from the delivery date until today, though it may be calculated off a specified date for analytical purposes. For example, if an engineering firm purchases a document scanner directly from Fujitsu on Net 30 terms and the scanner is delivered on Jan. 1, 2009, payment in full is expected on Jan. 30, 2009. On that day, the age of the account receivable is 30 days and the amount is the purchase price inclusive of any tax, shipping, handling, or other fees or expenses.

### SUMMARY

In accordance with the teachings of the present disclosure, disadvantages and problems associated with current approaches to exchanging business communications have been reduced.

In accordance with one embodiment of the present disclosure, a computer implemented method for facilitating business communications is provided. The method may include receiving a plurality of business transaction records from an accounting module; each business transaction record including an amount and a date. The method may also include providing a customer user interface configured to allow a first customer user, associated with a first customer, to search and access a first customer accessible subset of the plurality of unpaid business transaction records, the first customer accessible subset including only business transaction records associated with the first customer, and to participate in a first communication dialog, the dialog associated with one or more of the business transaction records in the first customer accessible subset. The method may further include providing an accounting user interface configured to allow the first accounting user to search and access an accounting accessible subset of the plurality of unpaid business transaction records, the accounting accessible subset including the first customer accessible subset, and participate in the first communication dialog.

In accordance with another embodiment of the present disclosure, a system for facilitating business communications may be provided. The system may include an interface to an accounting module configured to retrieve a plurality of business transaction records. The system may also include a database for storing the plurality of business transaction records. In addition, the system may include a customer user interface configured to allow a first customer user, associated with a first customer, to search and access a first customer accessible subset of the plurality of unpaid business transaction records, the first customer accessible subset including only business transaction records associated with the first customer, and participate in a first communication dialog, the dialog associated with one or more of the business transaction records in the first customer accessible subset. The system may also include an accounting user interface, configured to allow a first accounting user to search and access an accounting accessible subset of the plurality of unpaid business transaction records, the accounting accessible subset including the first customer accessible subset, and participate in the first communication dialog.

In accordance with yet another embodiment of the present disclosure, software on a tangible computer-readable medium is provided. The software may be configured to receive a plurality of business transaction records from an accounting module; each business transaction record including an amount and a date. The software may also be configured to provide a customer user interface configured to allow a first customer user, associated with a first customer, to search and access a first customer accessible subset of the plurality of unpaid business transaction records, the first customer accessible subset including only business transaction records associated with the first customer, and participate in a first communication dialog, the dialog associated with one or more of the business transaction records in the first customer accessible subset. The software may be further configured to provide an accounting user interface configured to allow a first accounting user to search and access an accounting accessible subset of the plurality of unpaid business transaction records, the accounting accessible subset including the first customer accessible subset, and participate in the first communication dialog.

Some, none or all of the following technical advantages may be found in one or more embodiments:

Certain embodiments may enable the sharing of transaction-based communications including associated documents between multiple organizations (e.g., two companies on the accounts receivable (AR) side and two companies on the accounts payable (AP) side) to expedite problem solving. For example, the communications can include invoice-based communication management via the Web and chronological communication management per invoice.

Certain embodiments may provide connectivity with ERP systems to allow access to invoice, order, and other information. In certain embodiments, one or more components of the present disclosure may reside outside a company's firewall to help protect the integrity of ERP data.

Certain embodiments may archive all communications, associated documents, and actions for future reference, audit and SOX compliance. This reduces the cost of paper processing, paper storage, printing, and distribution.

Certain embodiments may provide for control of information access by assigning permissions to properly authenticated users according to, for example, that user's individual profile, membership in one or more groups and/or organizations, or identified roles.

Improved productivity of knowledge workers in both accounts receivable and accounts payable may be provided in certain embodiments through the use of asynchronous communication and self-service invoice availability. Likewise, improved operational flexibility may be provided by allowing more than one individual to access communication within a controlled group to ensure the continuity of service in the event of, for example, sick leave, vacation, or replacement.

The benefits of such a system may include improved communication efficiency, efficient collaboration and exchange of information, seamless and secure access of data, independence from particular individuals in an organization, ease of dispute resolution with customers, and ease of regulatory compliance. It provides a “one stop service” that allows a business' customers to retrieve real aging data, invoices, credit memos PODs, order status, open/closed orders, scheduled shipment, delivery status and more. Such a system also may dramatically cut manual data entry tasks and human error associated with such tasks and may have a significant impact on headcount. It may also have minimal impact on existing systems (e.g., accommodates to any ERP system). The result is a highly efficient collection management tool that automates employee processes and improves response times to customers, vendors and auditors.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system architecture, according to an embodiment of the present disclosure;

FIG. 2 illustrates an example system diagram illustrating a mapping of data, users and systems, according to an embodiment of the present disclosure;

FIGS. 3a through 3c illustrate three example communication scenarios, according to certain embodiments of the present disclosure; and

FIGS. 4a through 4s illustrate various example screen shots from and documents that may be stored by and accessed through the system, according to certain embodiments of the present disclosure.

### DETAILED DESCRIPTION

Particular embodiments and their advantages are best understood by reference to the figures below. However, the present disclosure may be more easily understood in the context of a high level description of certain embodiments.

### System Overview

Improving the operational efficiency of workers is of paramount importance. For example, knowledge workers—or workers that create information and facilitate information flow within and between enterprises—spend an enormous amount of time searching for information relevant to business critical questions, often in vain. Studies have shown that knowledge workers spend more than twenty-seven hours a week searching, gathering and analyzing information. The studies also discovered that these employees spend three and a half hours weekly searching for information that is never found and three hours a week recreating content. The report claims that automating repetitive steps and eliminating tasks that waste time will increase worker productivity and could save organizations millions of dollars.

The present disclosure addresses many of the deficiencies in current systems and approaches to managing communications relating to business transactions. In particular, certain embodiments address the management of communications relating to accounts receivable. At a high level, the present disclosure addresses communication efficiency. This may include, for example, determining the appropriate target e-mail addresses for communications, providing a unified view of the communication history with the client, and automating responses to requests for duplicate documents. Further, the present disclosure aims to, for example, prevent dependency on an individual where that individual may become unable to timely respond to communications due to a heavy workload, absence from work, or worker turnover. The business communications discussed herein may also be archived to address issues of policy and regulatory compliance.

The challenges addressed by the present disclosure may be grouped into three categories: lost information, inefficient processes and noncompliance. Each is discussed in turn.

Lost information. When a document (invoice, credit memo or debit memo) is disputed, the knowledge worker has to follow the document's historical path to resolve the issues. When information is lost or difficult to locate, a number of business implications emerge. For example, as receivables age, metrics such as Days Sales Outstanding (DSO) increase, cash is tied up, customer satisfaction declines, productivity decreases, costs increase, and compliance issues may arise. Further, issues with older receivables are more difficult to resolve as information becomes less current and effectively “buried” by the continuous flow of new information. Older receivables are also an indication of bad debt, thus certain age thresholds may trigger expensive collection efforts or force a write-down of the debt. Too often businesses lose track of critical information with future value. For example, the information may inaccessible (due to permissions or an inability to properly search) to the individual seeking that information or the information may have been be permanently in the clean up process of email box. Finally, information may be lost when the only person who knew where it was leaves the company.

Process inefficiencies. A continuous flow of information in and out of a business does not stop when one piece is incomplete. Thus, when an entity (e.g., a customers, supplier, or a vendor) receives only partial information (due to an omission or because information is not presented in an integrated format), that entity cannot efficiently respond and the business relationship suffers. Furthermore, when information flows are people-centric, they lead to human error, excess labor burden, and opportunity loss. For example, consider a typical daily workflow of an accounts receivable collector. The collector must download aging information from the back-office accounting system (such as an Enterprise Resource Planning (ERP) system) to a spreadsheet application, format the data, and then fax it to the customer. These steps must be repeated for each customer. If the customer for some reason did not get the fax, the aging information must be resent. The process is repeated at a regular interval, e.g., once or twice a month. This manual process is labor intensive, error prone, and takes a significant amount of time to complete. This delay in providing information necessary for a customer to pay an invoice propagates into a further delay in payment. Any delay in payment ties up much needed cash and reduces the operational efficiency of a business.

Compliance issues. Poor information retention and responsiveness to inquiries may expose a business to legal problems and/or regulatory fines. Accounting and documentation requirements set forth by, for example, Sarbanes Oxley (SOX), Generally Accepted Accounting Practices (GAAP), and the Internal Revenue Service (IRS) impact nearly all businesses. Most rules and regulations focus on the retention and security of records, regardless of whether the information resides on paper or in electronic formats (e.g., email or PDF). Businesses need to know where information is, who has accessed it, if it is secured and how it can be retrieved. The burden of proof rests on the business. If documents are not centralized and traceable, it is very costly to respond to a regulatory audit.

The present disclosure addresses approaches to tracking historical information embodied by a system that integrates with the business process workflow to help an organization and its customers locate documents and track their progression through the document lifecycle. Content may be converged into an electronic system that enables clients, vendors and employees to efficiently act on information. As more documents are integrated and automatically delivered to knowledge workers, companies will begin to see significant efficiency improvements, be better able to handle the growing deluge of data, and quickly respond completely to audits without heavy burdens to the business. For example, when a customer wants to resolve disputes, all of the pertinent documents reside in the web space for them to access and generate a payment.

Embodiments of the present disclosure address the challenges discussed above through a system that enables communications between two or more parties regarding a particular transaction or document. Particular embodiments provide such communications for invoices in the collection group of an accounts receivable department (for communication with customers or other having corresponding accounts payable).

Although certain example embodiments are described in detail below, it should be understood that various changes, substitutions and alterations can be made to the embodiments without departing from their spirit and scope.

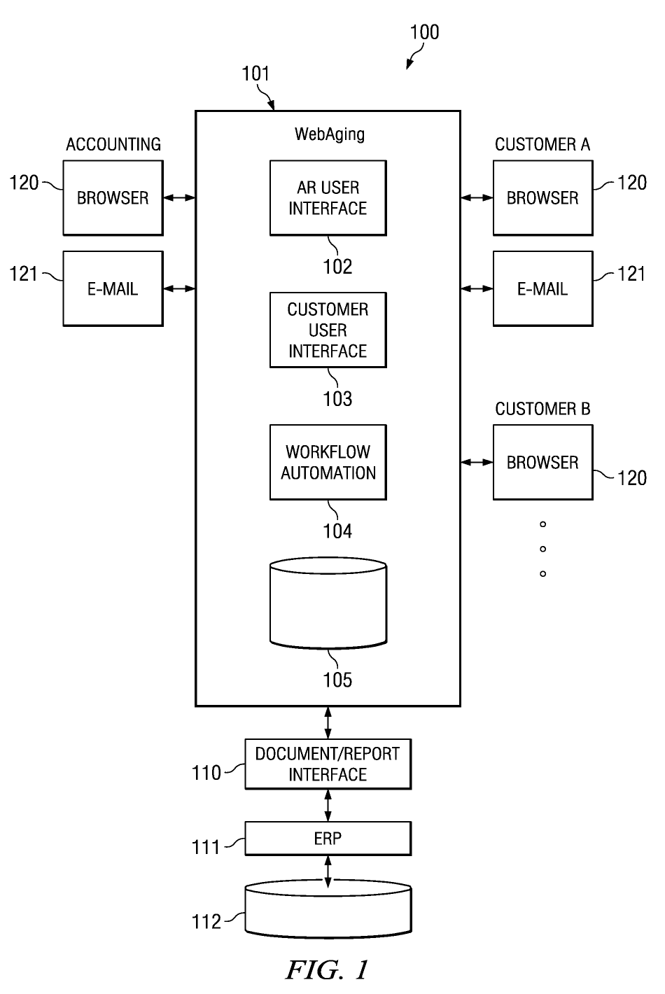

Preferred embodiments and their advantages are best understood by reference to FIGS. 1 through 4, wherein like numbers are used to indicate like and corresponding parts.

### Architecture

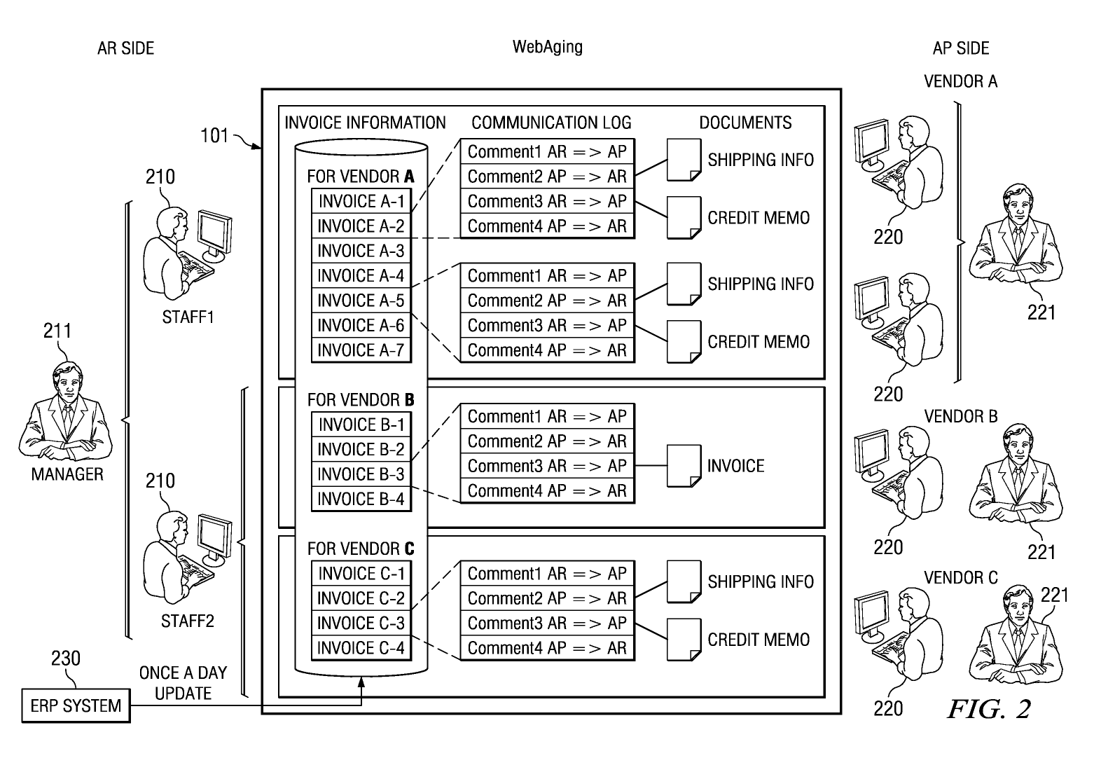

An example architecture of certain embodiments of the present disclosure is illustrated in FIGS. 1 and 2. As illustrated, this system provides a mechanism for exchanging information and communicating with customers via the web, thus eliminating person-to-person emails and lost data. All of the information regarding a document (e.g., an invoice) may be retained on the system at least until the invoice is paid or issue resolved. The system may also provide a communication log and/or discussion thread to allow, track, and preserve discussion, comments, and/or questions regarding the documents and/or the underlying transactions. The system also provides real-time aging with account balances, credit limit, payment terms, pending orders, which may be acquired periodically from the ERP system. Furthermore, the system may provide the ability to sort data, attach documents, export to a spreadsheet, and/or search for documents. Each document may be accessed directly via a hyperlink. In addition, the system may include an order center where a customer can view pending orders and/or closed orders along with, for example, scheduled shipment and/or delivery dates, delivery status, way bill number(s), delivery status, and hot links to delivery carriers.

FIG. 1 illustrates an example system architecture, according to an embodiment of the present disclosure. Communication system 100 includes WebAging system 101, document/report interface 110, ERP system 111, ERP database 112, web browsers 120, and email clients 121. WebAging system 101 further includes AR user interface 102, customer user interface 103, workflow automation 104, and WebAging database 105. WebAging system 101 may provide a centralized communication portal for accounting users (e.g., via AR User Interface 102) and customer users (e.g., via customer user interface 103) to view documents relating to sales of products and/or services. In addition, WebAging system 101 may enable users to view and/or generate messages relating to customer accounts and/or specific documents.

Communication system 100 is illustrated with Accounting users interfacing with one side of WebAging system 101 and Customer users interfacing with the other side. Accounting users may be employees (but may also be authorized contractors, agents or third parties) of the company selling products and/or services to customers and thereby generating accounts receivable. Accounting users are those users responsible for some task in the process of collecting on an account receivable. Customer users are employees (or other authorized individuals) of a customer and are tasked with some task related to authorizing or paying an amount owed to the selling company. This two-sided arrangement is carried forward in subsequent figures and provides a visual distinction of roles rather than a technical one. Other types and numbers of customer users may access the communication system 100 as well. Communication system 100 may include the hardware and software components embodying the present disclosure.

WebAging system 101 may be a computer (or a set of computers) running a web server (e.g., Apache), an application server (e.g., Apache Tomcat), and database 105 (e.g., MySQL, SQL Server and/or a set of flat files). WebAging system 101 may be built with an web application framework (e.g., Ruby on Rails™). WebAging system 101 provides integrated document management functionality along with a communications framework. WebAging system 101 receives and/or retrieves documents relating to sales of services and/or products from ERP system 111 via document/report interface 110. These documents may be, for example, detailed invoices or summary reports. WebAging system 101 stores these documents in database 105 for later retrieval.

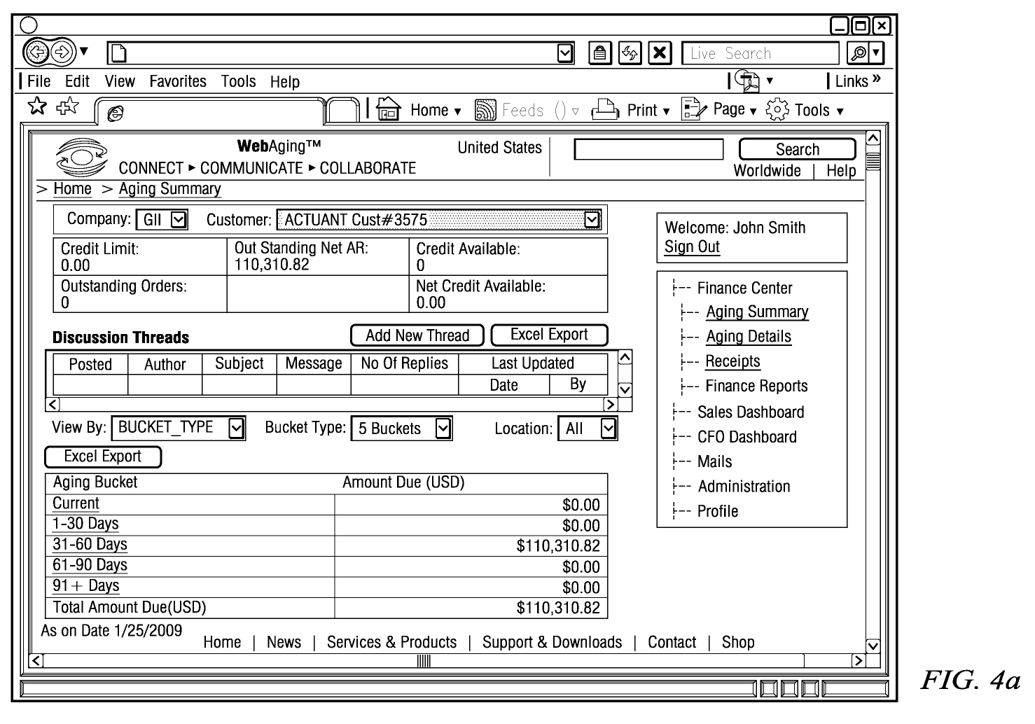

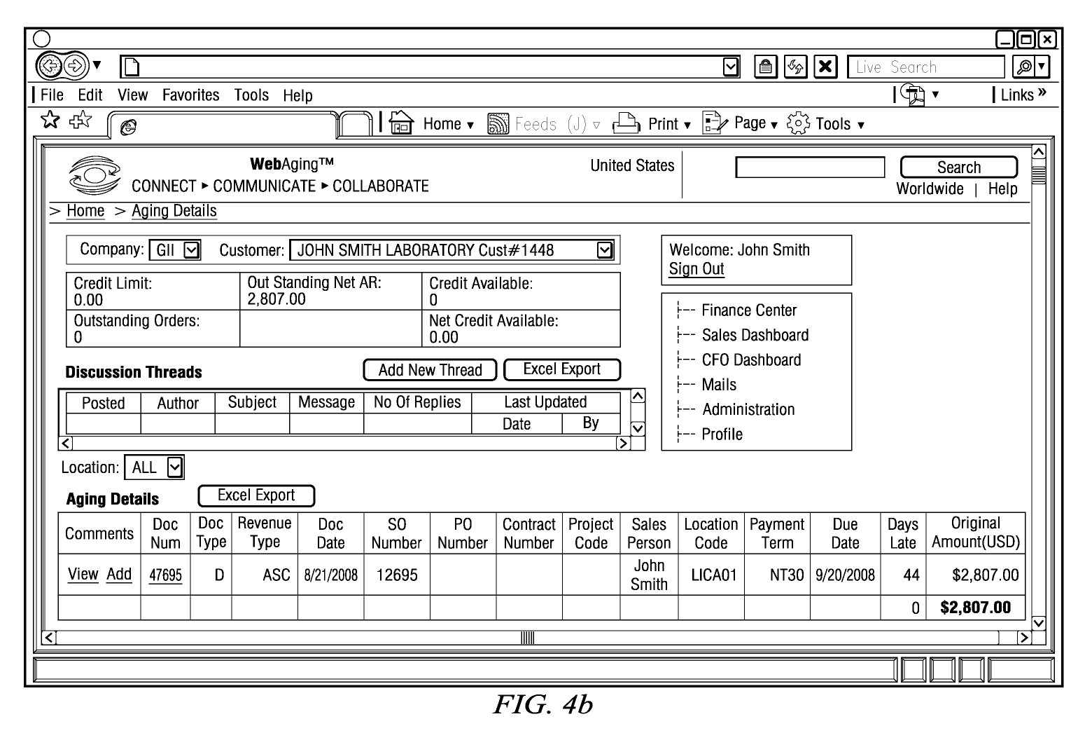

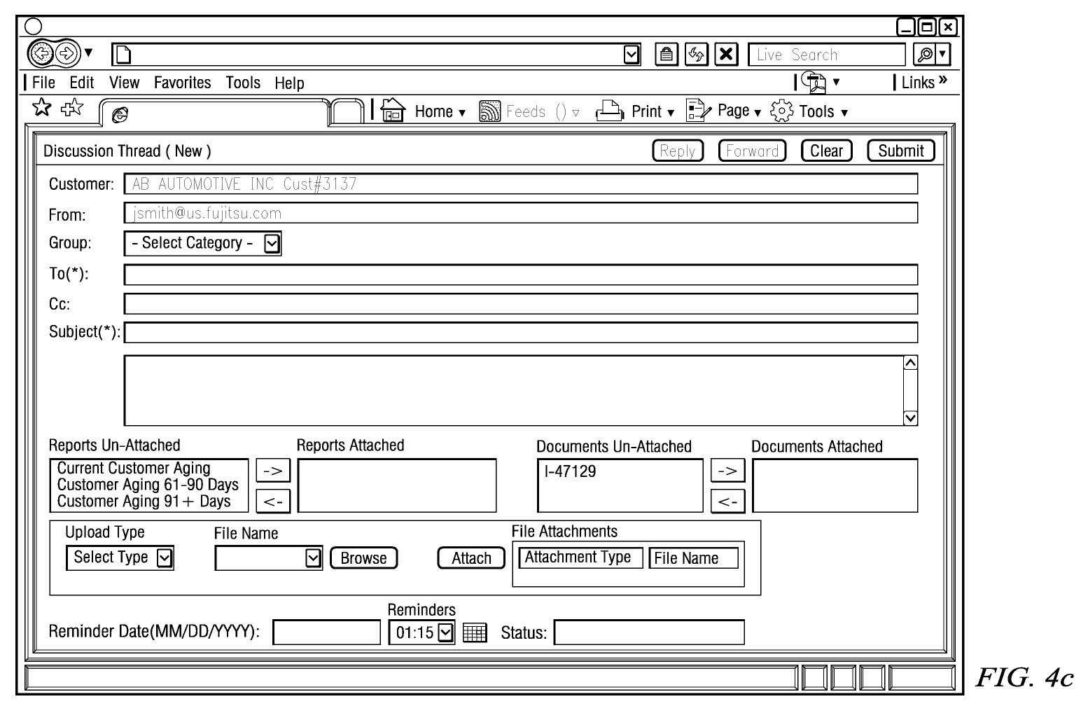

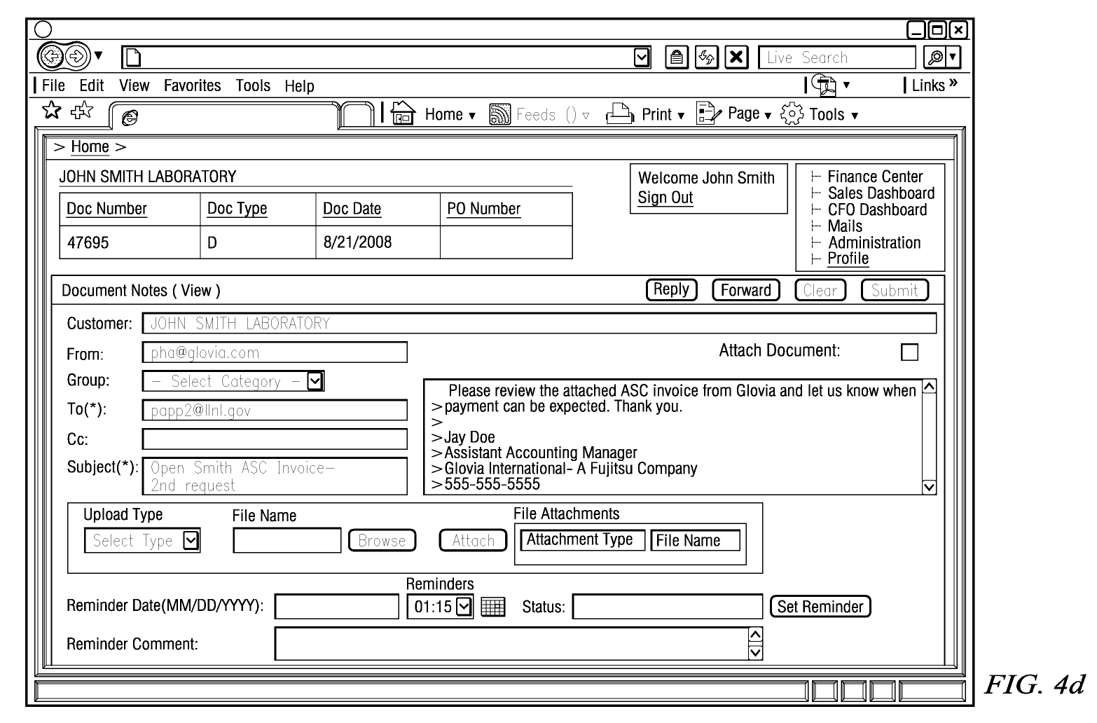

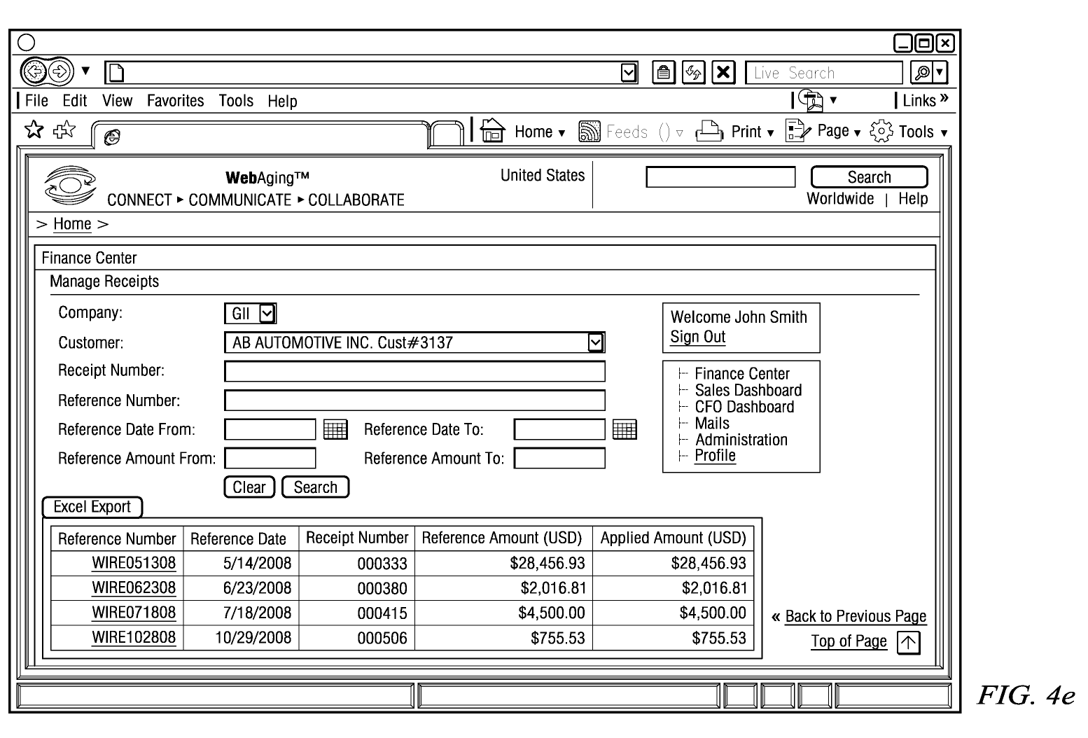

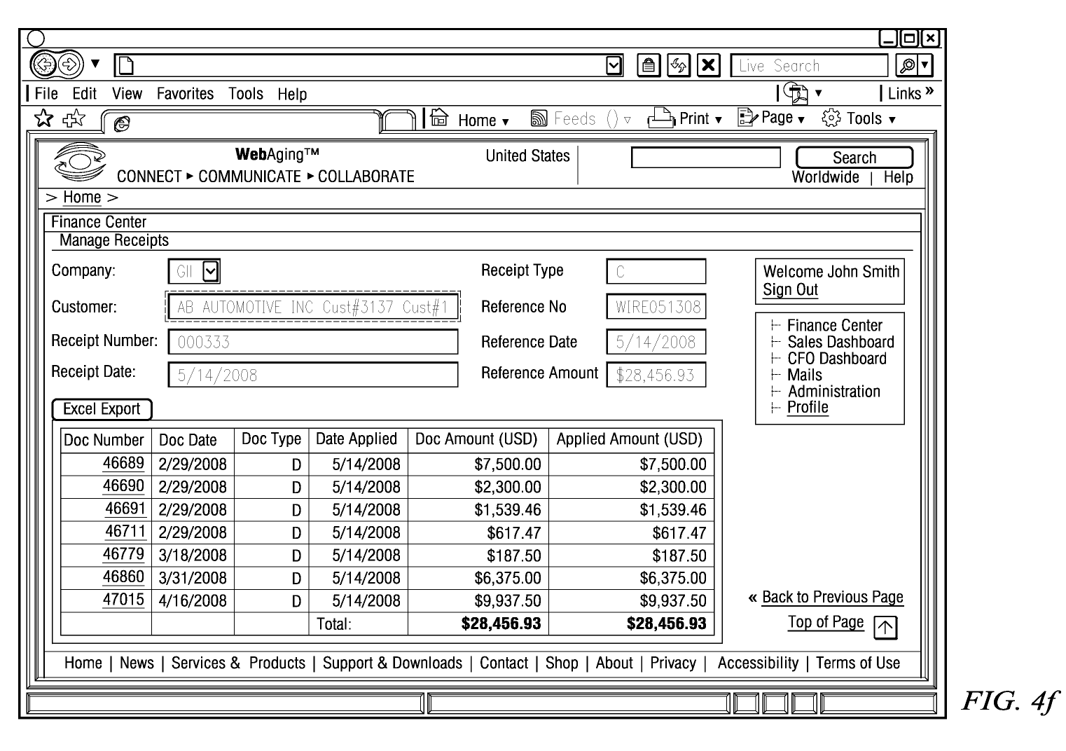

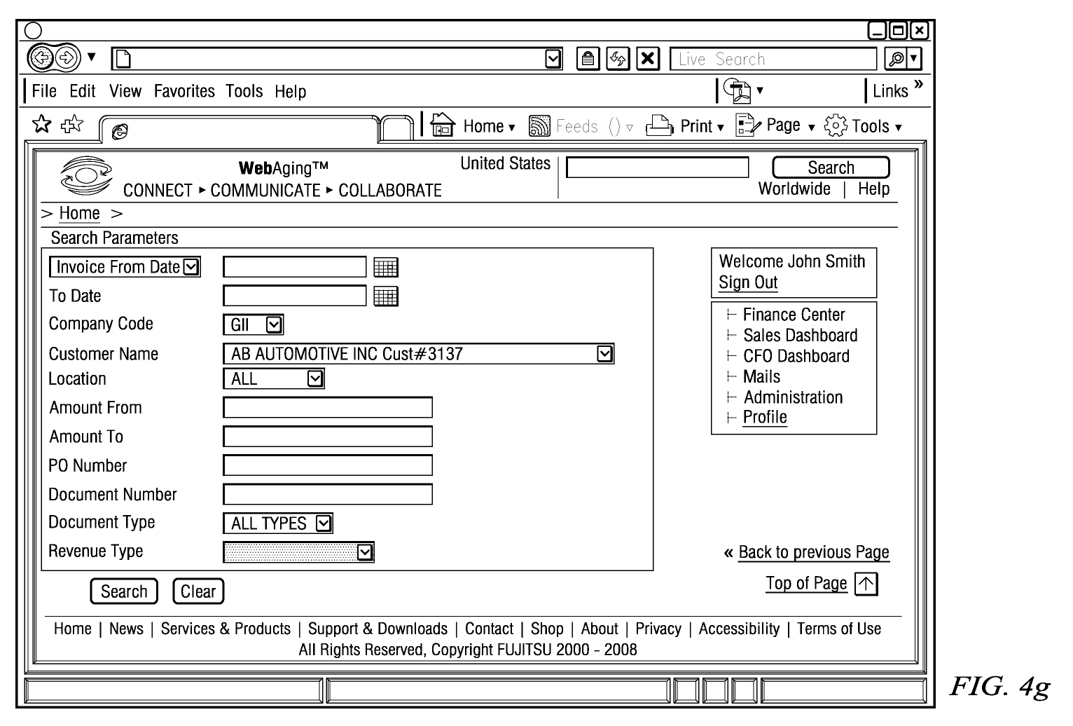

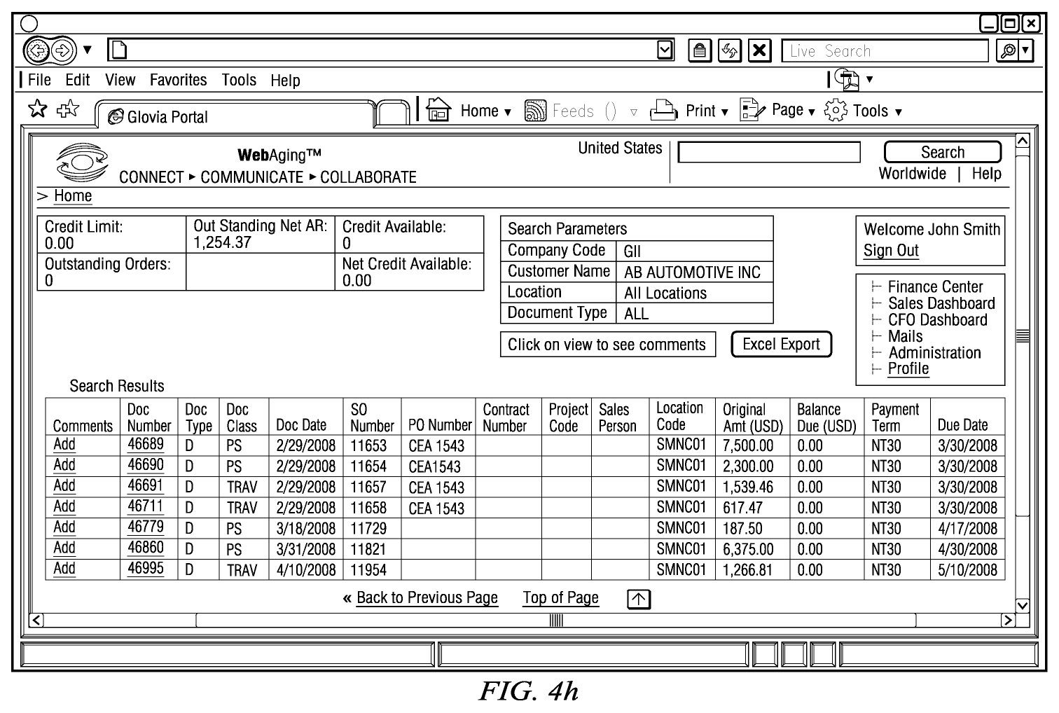

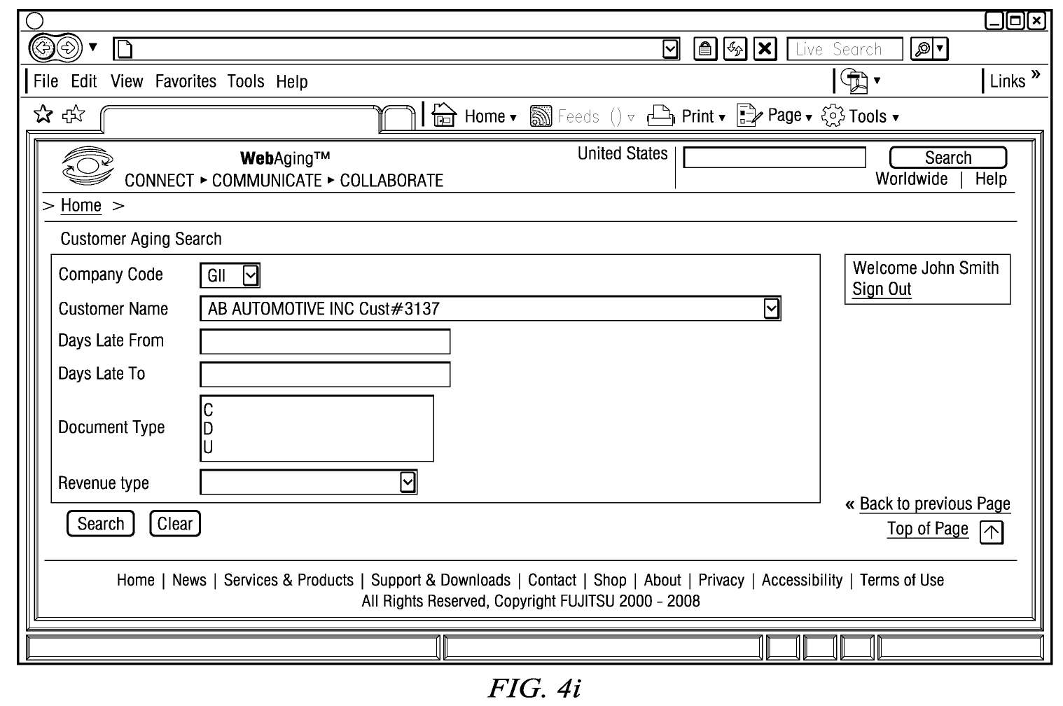

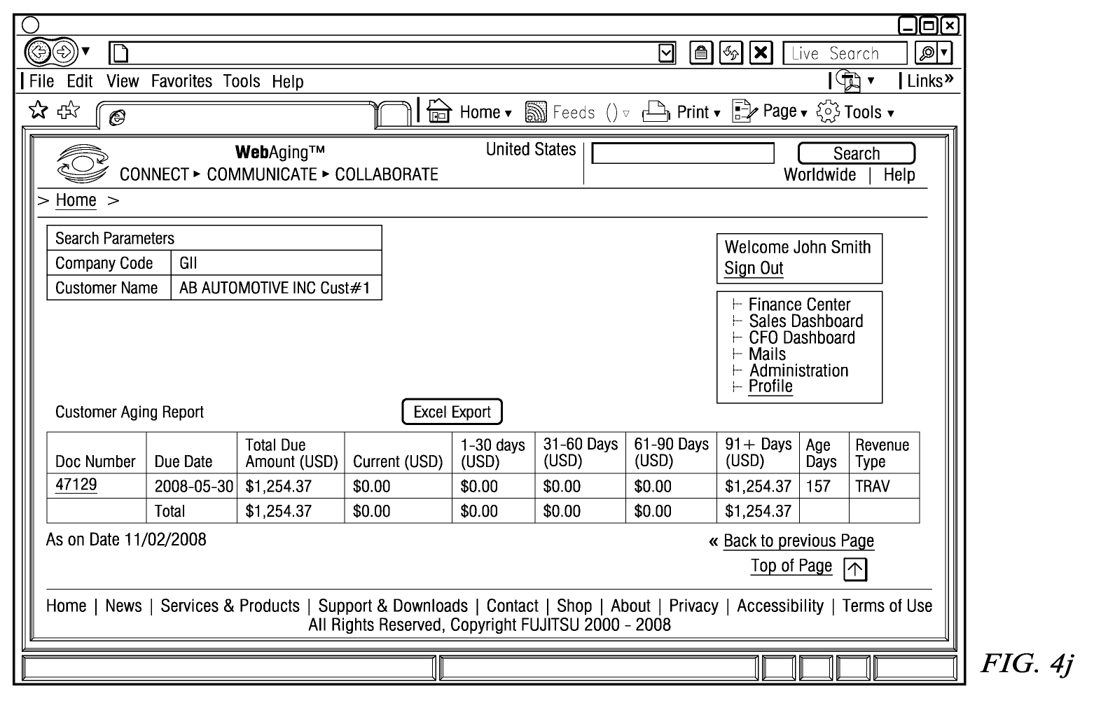

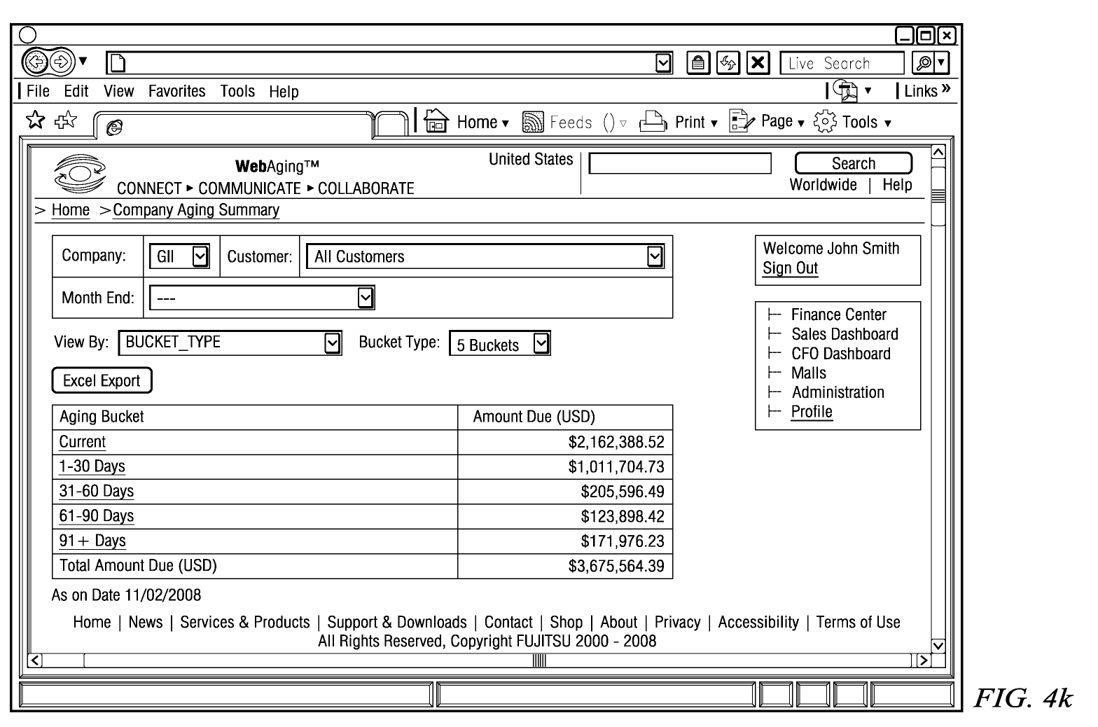

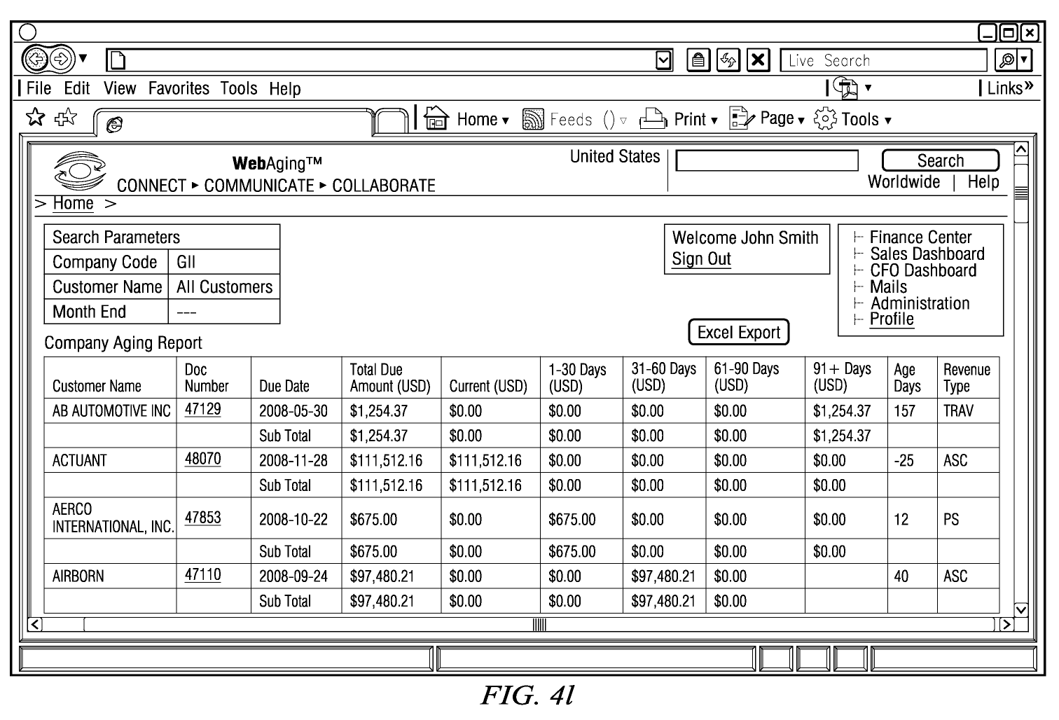

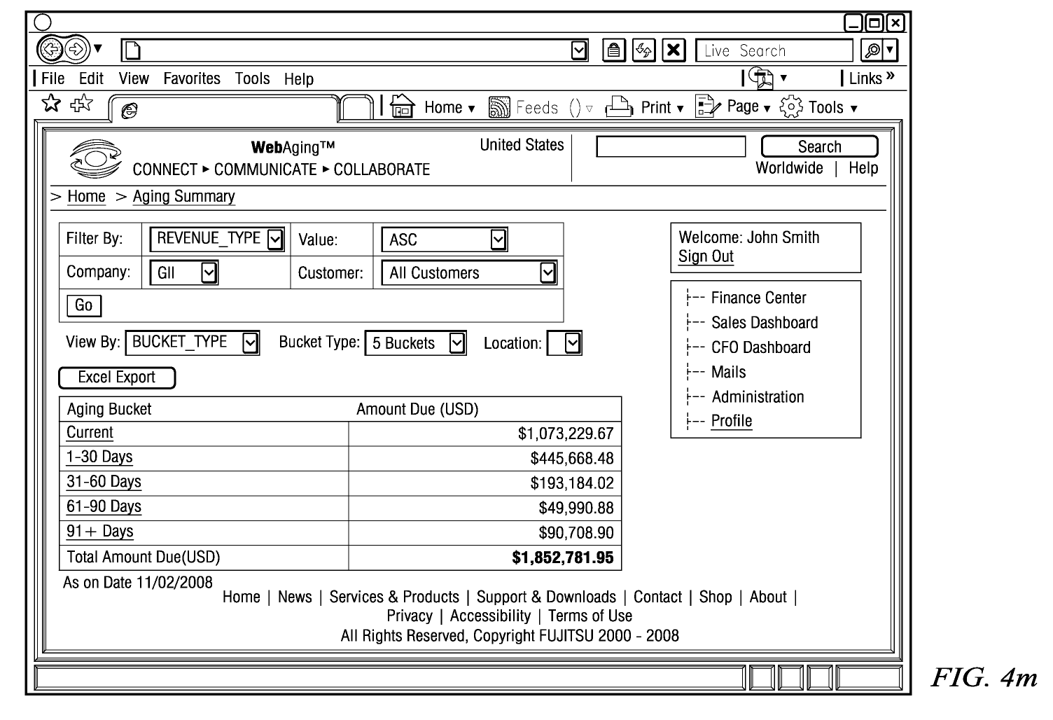

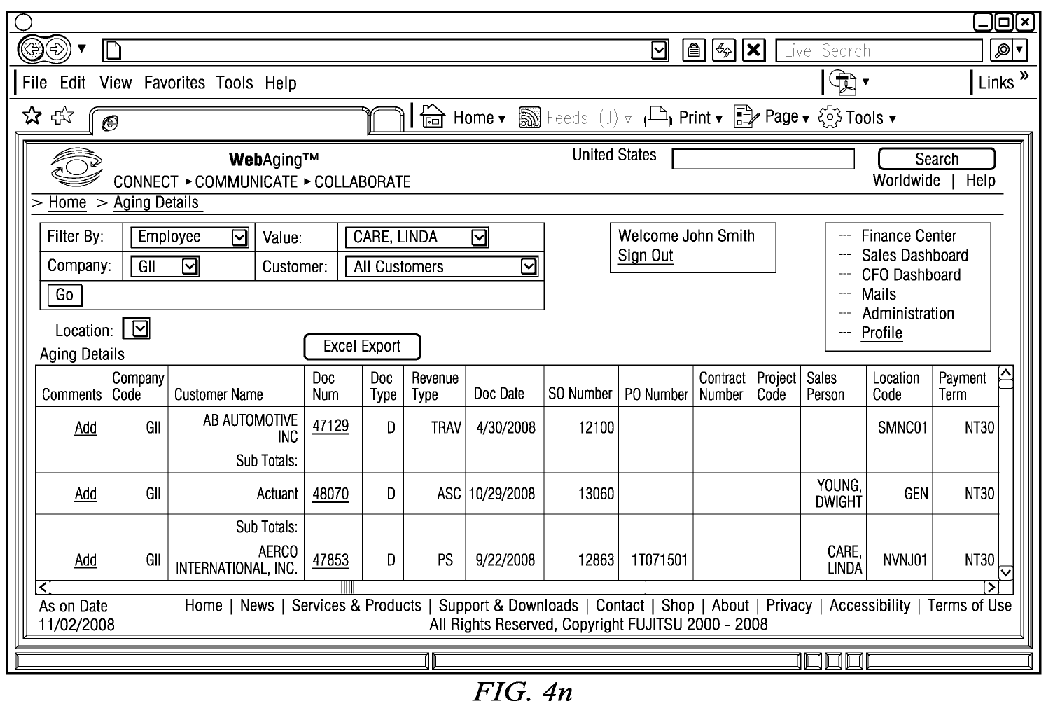

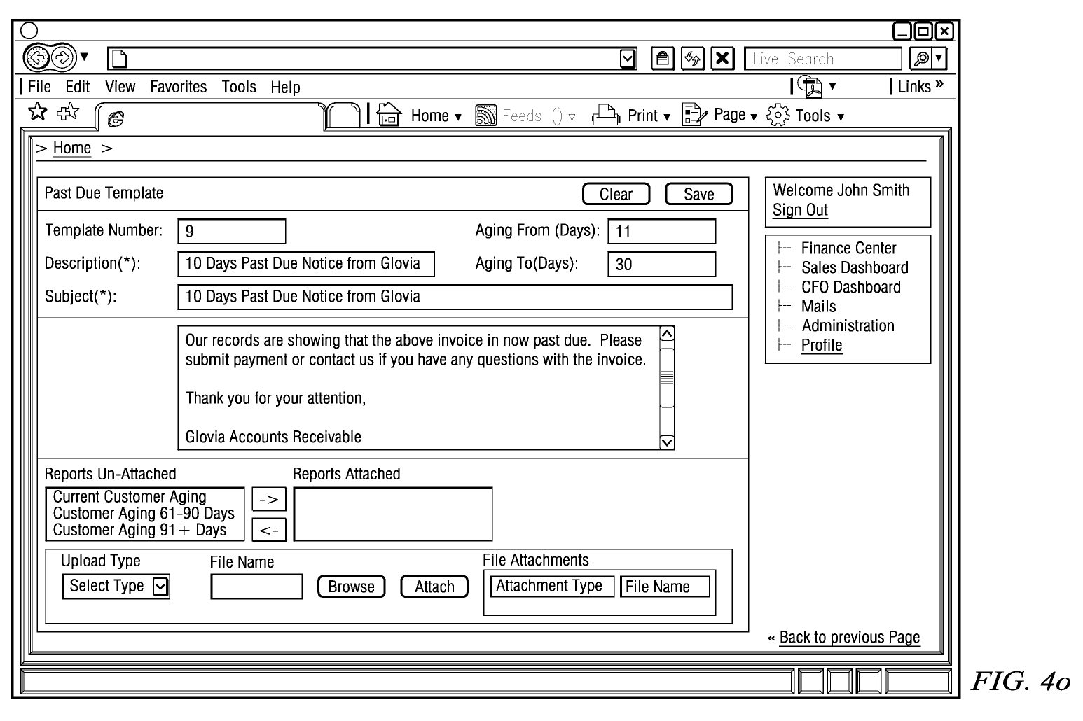

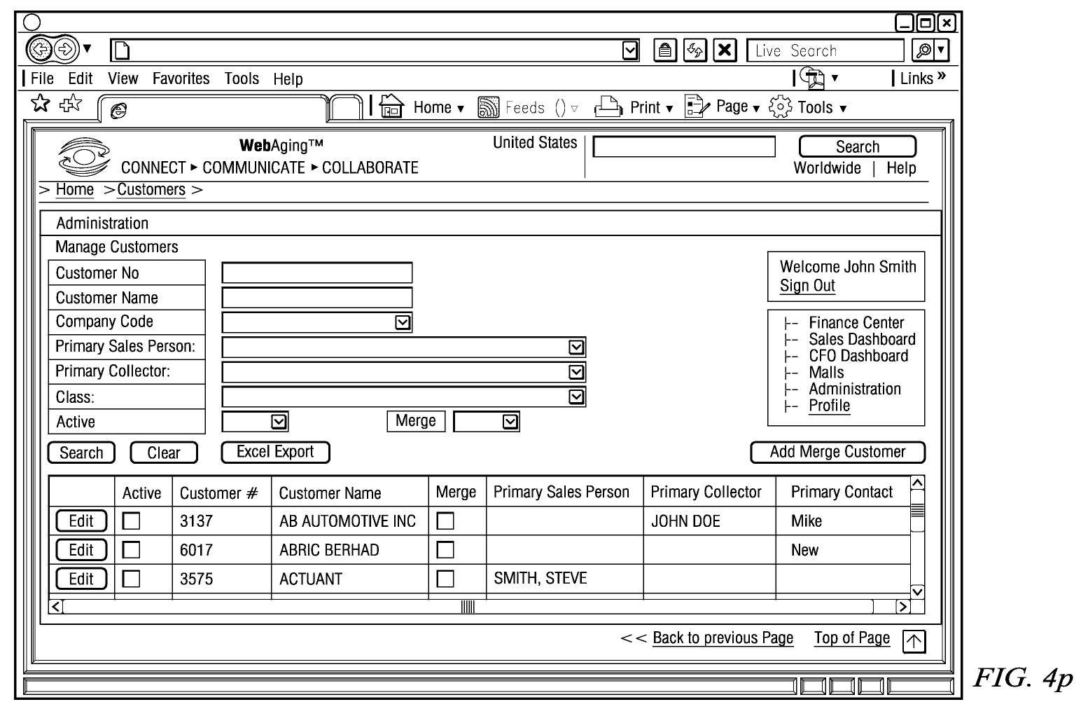

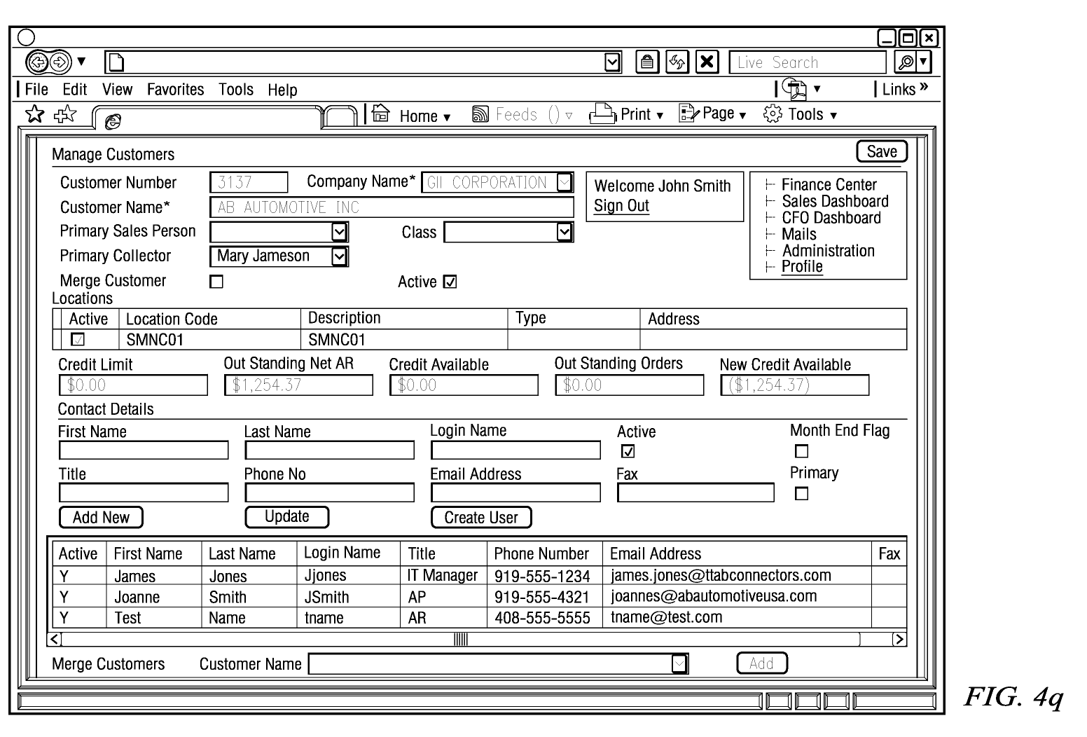

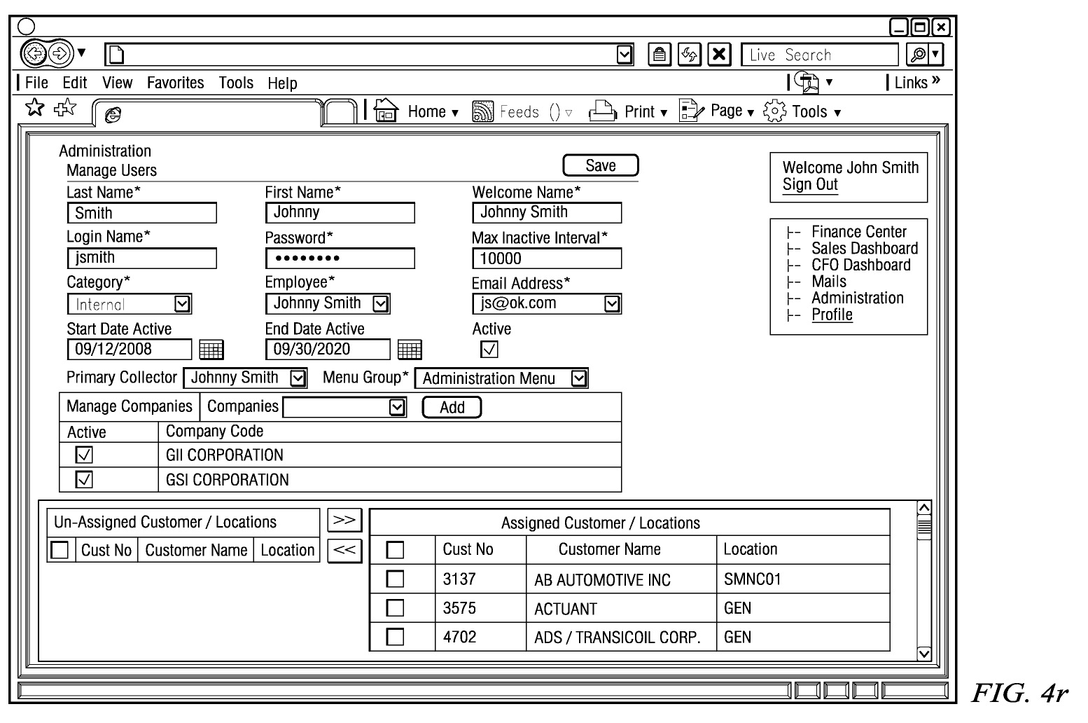

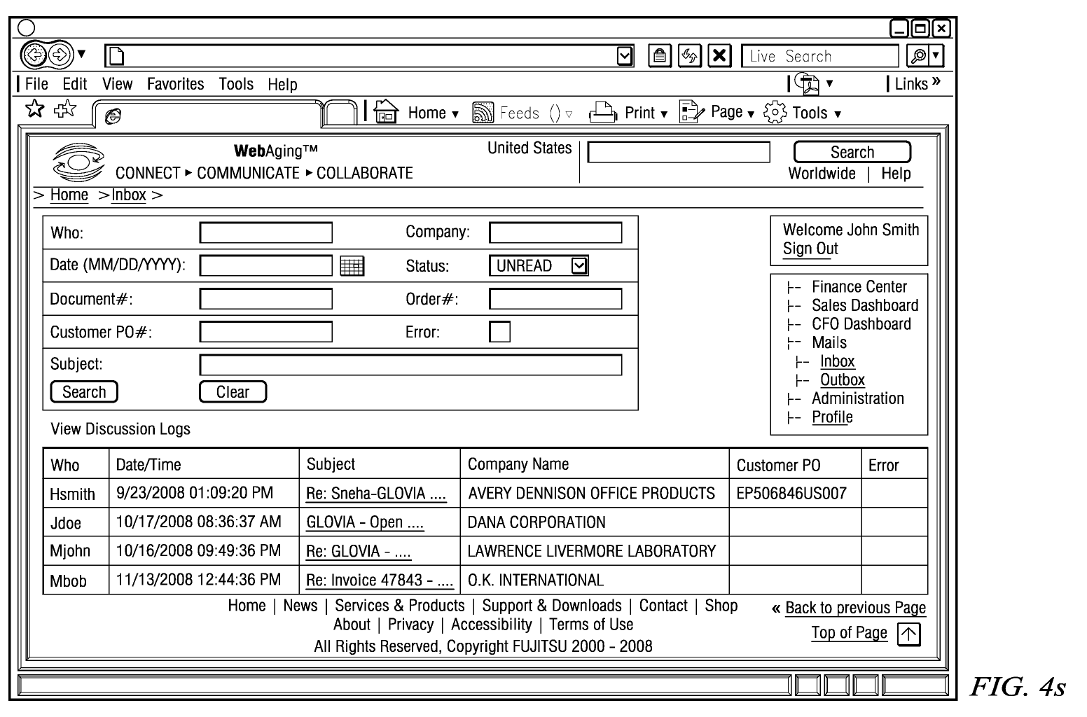

AR user interface 102 may be a set of message templates, message boxes, and/or interface screens that collectively enable an Accounting user to access the documents and message dialogs. AR user interface 102 may be a separate software module from customer user interface 103 or may be the same software module with different and/or additional functionality exposed to Accounting users than that exposed to Customer users. AR user interface 102 may be a set of screens generated by the web server and/or application server and rendered by browser 120 (e.g., Firefox™) and/or displayed as email 121. Alternatively, AR user interface 102 may be an application installed on an Accounting user's computer or access remotely via a remote application framework (e.g., Citrix®). Customer user interface 103 may be implemented in the same technology as AR user interface 102 or using an alternative technology (i.e., AR user interface 102 may be an application installed on Accounting users' computers while customer user interface 103 may be a web-based application). Examples of screens used in one or both user interface are shown and described below in conjunction with FIGS. 4a-4s. Lastly, email 121 may be any message protocol or system including, for example, SMS, email, or Lotus Notes®. Email 121 may include one or more hyperlinks enabling a user to click through to a relevant screen in AR user interface 102 or customer user interface 103 in order to respond to an inquiry.

Workflow automation module 104 may be generalized workflow engine and/or may be an application specific module programmed in any number of programming languages. Workflow automation module 104 may schedule some tasks to occur at specific times or intervals and may schedule other tasks to be event based. For example, in some embodiments, workflow automation module 104 executes a daily routine to contact document/report interface 110 for unpaid invoice documents and reports of accounts receivable. Workflow automation module 104 may save these new documents and/or reports into database 105 and perform any necessary initializations for each of those documents and/or reports (e.g., create an empty message thread or update a summary record). Further, workflow automation module 104 may archive and/or remove unnecessary documents and/or records (e.g., those relating to a paid invoice) from WebAging database 105.

At a regular interval, in some embodiments, workflow automation 104 may apply a set of threshold measures against each document and/or each set of documents for a given customer and generate a set of messages for one or more users. For example, if an invoice is older than some threshold age (e.g., 30 days) a payment reminder email 121 may be sent to the customer with a hyperlink a relevant screen of customer user interface 103. Workflow automation 104 may also keep a copy of that email (and any replies) in database 105 associated with the relevant invoice document. In another example, if an invoice is older than another threshold (e.g., 90 days) a notice email 121 may be sent to an accounting user, and including a hyperlink to a relevant screen in AR user interface 102, indicating possible bad debt or an unresolved question needing more urgent attention. Again, a copy of the email may be retained in database 105.

On the occurrence of certain events, in some embodiments, workflow automation 104 may take specific actions. For example, if an accounting user access ERP system 111 to modify an invoice, that user may also make a note in AR user interface 102. Workflow automation 104 may then, or after a predetermined delay interval, query document/report interface 110 for the updated invoice and save the updated invoice in database 105. In addition, workflow automation 104 may automatically generate email 121 to the invoiced customer with a hyperlink to a relevant screen on customer user interface 103 where the customer can download a copy of the updated invoice.

Document/report interface 110 may be a software module that provides access by WebAging system 101 to documents and reports mastered in ERP system 111. Document/report interface 110 may be part of ERP system 111 or may be external to ERP system 111. Further, Document/report interface 110 is illustrated as communicating with ERP system 111, but may actually contact ERP database 112 directly. ERP system 111 (e.g., Glovia®) may be a dedicated accounting system or may be a full engineering resource planning system that includes accounting functionality. ERP database 112 is the operational database used by ERP system 111. As mentioned above, document/report interface 110 may be queried by workflow automation module 104 when triggered or on a regular interval. The design of many existing ERP systems makes each query relatively expensive in terms of time and computing requires required to complete the operation. Thus, in certain embodiments, document/report interface 110 may be queried no more frequently than once or twice a day. A twice-a-day query schedule may be appropriate where accounting operations run continuously and may also be appropriate in embodiments where the second query in a given day is only made when requested. In other embodiments, however, more frequent queries (e.g., hourly) or less frequent queries (e.g., every other day or weekly) may be feasible and queries may also be requested on-demand.

FIG. 2 illustrates an example system diagram illustrating a mapping of data, users and systems, according to an embodiment of the present disclosure. WebAging system 101 is illustrated as a set of data records, some of which are updated daily from ERP system 230. On the accounting side, accounting manager 211 may be associated with accounting staff members 210 indicating a supervisory relationship. Likewise, on the customer side, each customer staff member 220 may be associated with customer manager 221. The illustrated supervisory relationships are merely an example and WebAging system 101 may handle other relationships as well. For example, some customer staff members may have no supervision (e.g., sole proprietorships or partnerships without employees) while others may have layers of supervision or multiple supervisors (e.g., in large organizations). These supervisory relationships may allow a supervisor to step in for or reassign responsibilities for a staff member in the event that the staff member is overworked, ill, or has left the company. Further, some activities or tasks may require supervisory approval or attention. A user's role may be used by WebAging system 101 to determine that user's visibility into the system.

In certain embodiments, WebAging system 101 may include three categories of information (invoice information, communication log, and documents) for each customer. Invoice information may include summary information (e.g., total value, invoice number, date, etc.) and an electronic representation of the contents of that invoice (e.g., line items indicating what was sold, a quantity, a price, etc.) The electronic contents may be useful in running real-time reports, exporting to a spreadsheet application, searching, and other common tasks. The communication log may include, for example, internal messages, email communications, text messages, chat logs, or any other type of communications. Documents may include, for example, invoices, credit and debit memos, shipping records, or any other documentation relating to sales of services and/or goods. These documents may be stored in a number of formats, but will commonly be stored in PDF or TIFF format to preserve formatting and content. Documents may be scanned or electronically generated.

To illustrate the data relationships, FIG. 2 shows data sets (including invoice information, communication logs, and documents) for three different vendors, Vendor A, B, and C. Each vender has several associated invoices, with each invoice having zero or more associated communication log entries and zero or more associated documents. One example data set will be described more fully. For vendor A, Invoice A-2 is associated with four messages, two of which are associated with one document each. This data arrangement may represent the following dialog. First, accounting staff 210 labeled Staff1 initiated a message to customer A inquiring as to a timeline for payment of invoice A-2 (e.g., Comment1). Customer staff 220 with Customer A responded that there was a problem with shipment and attached a document with shipping information (e.g., Comment2). Accounting manager 211 then responded by crediting Customer A and attaching a copy of the credit memo (e.g., Comment3). Finally, customer staff 220 responded with payment instructions for the remaining balance on invoice A-2 (e.g., Comment4).

In this example, accounting staff 210 (labeled Staff1) and accounting manager 211 have access to the invoice information, the communication log, and the documents relevant to Customer A. Similarly, customer users 220 and customer manager 221 with Customer A have access to data relevant to Customer A. However, some documents and/or communication log entries (e.g., a confidential dialog between accounting users about the accuracy of a calculation or a request for approval of a course of action) may only be visible to accounting staff 210 and accounting manager 211.

Further, FIG. 2 illustrates another data relationship enabled by certain embodiments. Accounting user 210 (labeled Staff2) has visibility into information relating to Customers B and C while accounting manager 211 has visibility into all information. Likewise, Customers A and B might have a common corporate owner and therefore might have a customer manager 221 with access to information relating to both Customer A and B.

### Communication Scenarios

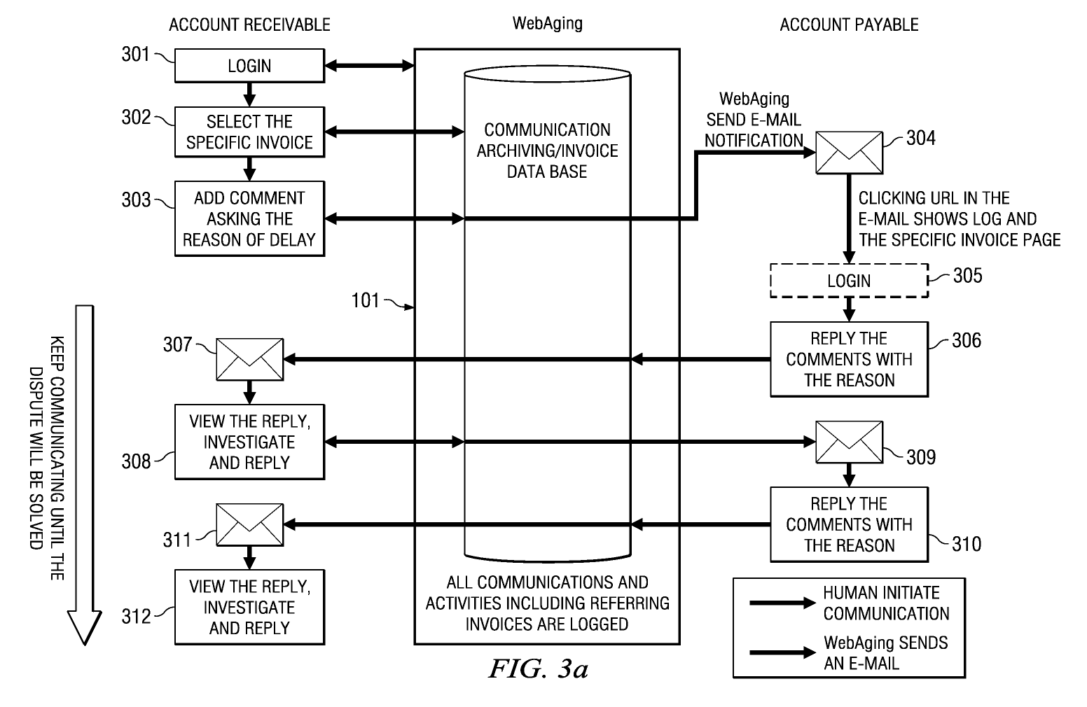

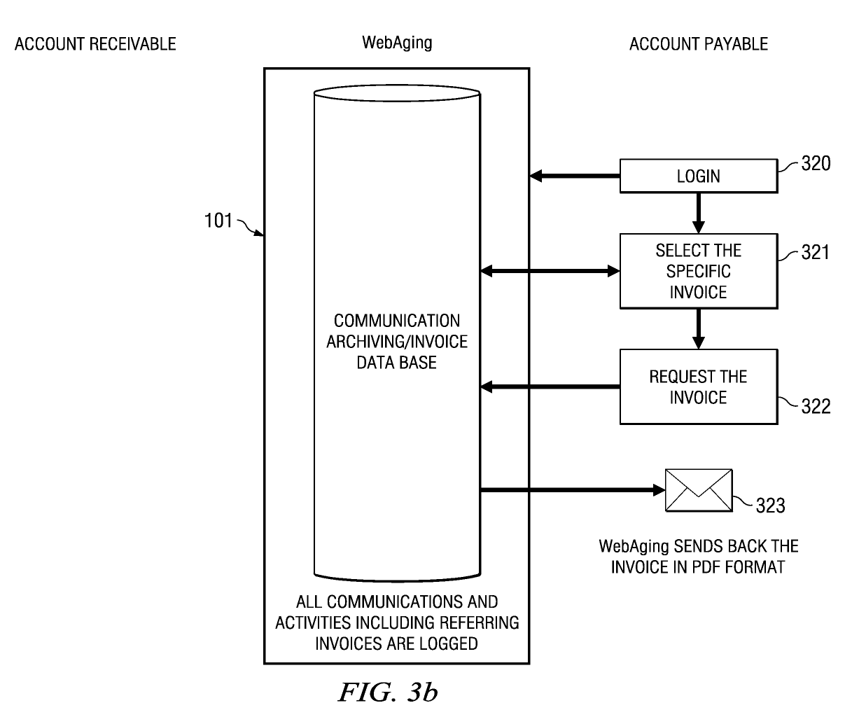

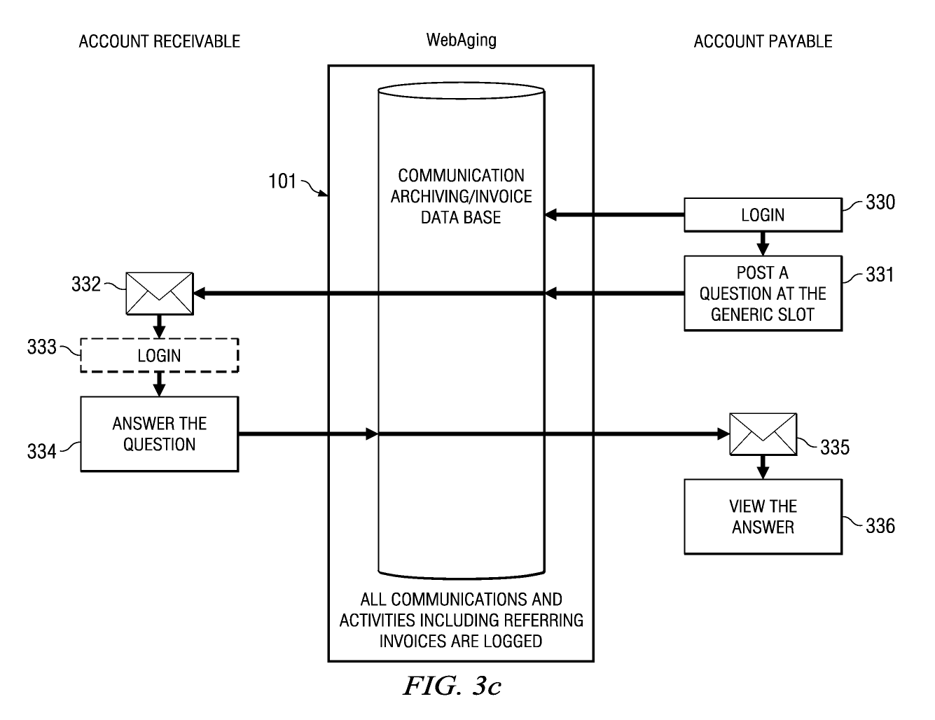

FIGS. 3a through 3c illustrate three example communication scenarios using the system of FIGS. 1a, 1b, and 2, according to certain embodiments of the present disclosure. FIG. 3a illustrates a communication using the system between an accounts receivable (AR) department of one company and an accounts payable (AP) department of another company regarding a payment delay on a specific invoice. FIG. 3b shows a communication of an AP department with the system to obtain a lost invoice. FIG. 3c shows a communication using the system where an AP department asks a question of an AR department and gets an answer.

In FIG. 3a, an accounting user initiates the process by logging in (301) to WebAging system 101. The accounting user selects (302) an invoice of interest, possibly from a list generated by a search or flagged by the workflow module (discussed more fully in conjunction with FIG. 1a). The accounting user then adds a text comment (303) asking why the invoice has not yet been paid. The workflow module then generates an email notification (304) to one or more customer users. By selecting the hyperlink in the email notification, a customer user logs in (305) to WebAging system 101. The customer user has the opportunity to review the invoice and any previously entered comments and replies (306) with a reason that payment has not been made. The workflow module generates an email notification (307) sent to an accounting user, possibly a different one. The accounting user views the reply (308) and may conduct an investigation. Steps 309 and 312 are merely a continuation of the same dialog and may be repeated as necessary.

In some embodiments, the email notifications may be turned off by a user where that user regularly logs in to the system and may view notifications directly on the user interface screens. This may be most applicable for accounting users, but may also apply to customer users for customers with frequent and/or complex transactions. As a fail-safe, the workflow module may be configured to send an email notification if a user if a message has been unread for more than a threshold number of days (e.g., two business days or one week) or if a threshold number of unread messages has been surpassed.

In FIG. 3b, a customer user initiates the process by logging in (320) to WebAging system 101. The customer user then selects a specific invoice (321) from, for example, a list of all possible invoices, a subset generated by a query, or a subset flagged by the workflow module as having triggered one or more threshold conditions. The customer user then requests a copy of the invoice (322) to be delivered via email. The workflow module sends an email (323) to the customer user with a copy of the requested invoice attached. This scenario may be useful to a customer user with limited network connectivity (e.g., using a mobile device). The user could request an invoice and then forward the email (with the attached PDF) to a colleague without having to open the PDF document.

In FIG. 3c, a customer user initiates the process by logging in (330) to WebAging system 101. The customer user then enters a question (331) that is not specific to an invoice or report. For example, the question might relate to a proposed change in payment terms or a request for a credit line increase. WebAging system 101 then generates a notification email (322) to an accounting user, the email containing a hyperlink to a screen with the message. The accounting user then logs in (333) and reads the question. The accounting user enters a response (334) to the question triggering an email notification (335) to the customer user. Finally, the customer user views the answer (336).

### Screen Flows

FIGS. 4a through 4p illustrate various example screen shots from and documents that may be stored by and accessed through the system of FIGS. 1 and 2, according to certain embodiments of the present disclosure. The specific fields, arrangement of elements, and choice of user interface components (e.g., dropdown boxes and buttons) should not be viewed as limiting and may be varied based on, for example, the implementation technology used, usability requirements, customer feedback, and other requirements.

FIG. 4a illustrates an example aging summary for a selected customer as viewed by an accounting user. An aging summary provides a high-level summary of the accounts receivable for a given customer and any pertinent discussions about those accounts receivable. Fields will be described from top to bottom. The company field, here “GII” is selected, represents a business entity offering goods or services to customers. In some embodiments, this field allows the system to manage communications for multiple subsidiaries or divisions of a large company. The customer field, here “ACTUANT Cust#3575” is selected, determines which customer will be the subject of the report. Just below the company and customer fields, a summary provides visibility into, for example, the customer's credit limit, total outstanding debt (e.g., net AR), available credit, outstanding orders and net credit available.

The next major section displays discussion threads and offers the ability to create a new thread and to export the current threads to a spreadsheet (e.g., Microsoft Excel®). Each existing thread (here, there are none) will be displayed including, for each thread, the initial posting date, the author, the subject, the message body, the count of replies to the message, and a record of the date and author of the last person to add to the thread.

The last major section displays a bucket view of accounts receivable for the selected company and customer. Each bucket has an associated timeframe and summarizes the accounts receivable that fall within that timeframe. For example, a bucket of 31-60 days will contain all accounts receivable at least thirty-one days old but not more than sixty days old. The number of buckets may be selected as can the customer location (e.g., the customer's Midwest distribution center or the customer's Southeast distribution center). A spreadsheet export option is available to the user as well.

FIG. 4b illustrates an example aging details screen of the system. As with FIG. 4a, an accounting user may select a company, a customer, and a customer location. Based on those selections, the WebAging system displays a detailed display of each associated document showing, for example, links to view or add comments on the document, the document number and hyperlink to an image of the document, the document type (e.g., invoice, debit memo, credit memo, cash in advance memo), revenue type, document date, sales order number, purchase order number, contract number, project code, sales person, location code, payment term, due date, days late, original amount, etc. A spreadsheet export option is available to the user as well.

FIG. 4c illustrates an example new discussion thread screen of the system. The first two fields (i.e., customer and from) have been automatically populated based on the user's context and are shown grayed out. Specifically, the customer field has been populated as “AB AUTOMOTIVE INC Cust#3137” because the accounting user had this customer's record open when she chose to create a new discussion thread. The accounting user completes the “to” and cc fields to specify the intended recipients for an email, which will be generated by the workflow automation module once the message has been submitted. In certain embodiments, the accounting user assigned to the customer as primary collector will also receive a copy of the email. The accounting user entering the form next completes the subject field and message body.

Additional fields are present for attaching predefined reports as spreadsheets, attaching existing documents (e.g., invoices, credit memos, debit memos, and cash in advance memos), and uploading new documents (e.g., a spreadsheet generated elsewhere or a letter received from the customer) as attachments. Finally, the accounting user may create a reminder date and time (and subsequently update the status field). This reminder may only be visible to accounting users and may be displayed on a login screen or may be used by the workflow automation engine to trigger, for example, an email at the specified date and time.

FIG. 4d illustrates an example screen for viewing a discussion thread associated with a particular document. This screen is similar to that in FIG. 4c in that it contains fields common to many messaging systems, but also contains a header identifying a specific document by, for example, document number, date, and type as well as by purchase order number. This screen differs from that in FIG. 4c in that it is already document specific, so there may be no mechanism for attaching reports or preexisting documents (other than the sole associated document). There remains a mechanism for uploading and attaching new documents (e.g., a spreadsheet document or scanned letter).

FIG. 4e illustrates an example screen for managing receipts. This screen allows an accounting user to specify a company and customer to search for payment receipts. This screen provides a mechanism for an accounting user to determine whether or not a promised payment has actually been processed. This screen provides additional fields for narrowing the search including receipt number, reference number (hyperlinked to the receipt application screen illustrated in FIG. 4f below), reference date, and reference amount. The underlying search engine may also provide wildcard support to allow a user to search for all wire transfers by entering, for example, “WIRE*” into the reference number search field. In addition, an option is provided for exporting the search results to a spreadsheet.

As with many of the screens described herein, this screen may be offered to customer users. A user and role based authentication scheme would limit the customer user's visibility to only those companies and customers properly associated with that customer. This access control is discussed in reference to FIG. 2 above.

FIG. 4f illustrates a receipt application screen. A receipt is a record of funds received, e.g., via wire transfer or check. These funds may be applied to one or more documents, e.g., invoices. The example illustrated here applies a payment of $28,456.93 to seven different debit memos. This might indicate a scenario wherein the company, e.g., GII, has provided services on seven occasions and the customer, e.g., “AB AUTOMOTIVE INC”, has made a single wire transfer to pay the entire debt. This screen is presented once a user clicks on a reference number in the results portion of the receipt search screen illustrated in FIG. 4e above. The receipt details are displayed in the top portion of the screen along with the customer and company. In the bottom portion of the screen is a list of documents to which the receipt amount was applied. For each of these documents, the document number, date, type, and amount is displayed along with the date on which some or all of the receipt amount was applied and the actual amount of the receipt that was applied to that document. In addition, an option is provided for exporting the document list to a spreadsheet.

FIG. 4g illustrates a document search screen. This screen allows a user to build a search query based on a number of criteria. For example, by date range, company, customer, location, amount range, purchase order number, document number, document type, and/or revenue type. This set of available parameters is merely illustrative and may include more or fewer fields. Further, the illustrated screen may apply a logical AND to any entered parameter. In certain embodiments, a query may be built with logical OR operators enabling a more robust search capability. This additional functionality may be enabled through a free-text box such as that used in many online researching applications or may be implemented as a selection of predefined complex search types provided by system administrators based on user requirements.

FIG. 4h illustrates a document search results screen. This screen allows a user to view the document search results and interact with those results. At the top of the screen is a set of summary information about the customer, e.g., current credit limit, outstanding net accounts receivable, available credit, outstanding orders, and net credit available. In addition, the search parameters are shown for reference purposes. Each document search result may be displayed with, for example, a hyperlink to any existing comments, a hyperlink to add a comment, a document number hyperlinked to a document detail screen, a document type, a document class, a document date, a service order and/or purchase order number, a contract number, project code, sales person, location code, original amount, balance due, payment terms, due date, etc. An option is provided to export this list as a spreadsheet.

FIG. 4i illustrates a customer aging search screen. This screen allows a user to search for documents associated with past due customer obligations. A user may specify a company, a customer, a range of days late, a document type, and a revenue type.

FIG. 4j illustrates a customer aging report screen. This screen provides a mechanism for a customer to view the age of their accounts payable to the company. This screen displays the search parameters at the top and offers a spreadsheet export option. The content of the report lists each document with an unpaid amount (hyperlinked to the document detail screen), the due date, the total due, an amount due for each bucket (e.g., current, 1-30 days, 31-60 days, 61-90 days, 91+ days), the age in days, and the revenue type. At the bottom of the list are totals for all of the listed documents.

FIG. 4k illustrates a company aging summary screen. This screen provides a summary view to an accounting user for the whole company or for a specific customer. The accounting user may specify the company and customer as well as the view (e.g., in buckets) and a view parameter (e.g., five age buckets). The results are displayed as a table of the total amount due in each of the five age buckets as well as a grand total due. By default, the screen generates these totals as of the current day. However, the accounting user may specify a past month end to show the same information as of an earlier date. This may allow an accounting user to compare the current aging scenario for the company or a customer with prior time periods. While it is never good for a customer to have old receivables, a pattern of old receivables over several periods may indicate a bad credit risk or overly generous payment terms. An option is provided to export this summary to a spreadsheet.

FIG. 4l illustrates a company aging detail report screen. This screen provides a mechanism for an accounting user to view the age of their accounts receivable for a company across one or all customers. This screen may result from a search entered in a screen like that illustrated in FIG. 4i. At the top of this screen, the selected search parameters are listed. The aging report, with an option to export to a spreadsheet, is the same detail as shown in the customer aging report illustrated in FIG. 4j with the addition of a customer name column.

FIG. 4m illustrates a company aging summary screen similar to that in FIG. 4k, but with an additional filter option for revenue type. This screen may be accessed by an accounting user such as a chief financial officer. The summary display may be identical to that in FIG. 4k. As with FIG. 4k, a parameter may be added to this screen to generate summaries for a particular “as on” date.

FIG. 4n illustrates a company aging detail report screen similar to that in FIG. 4l, but with an additional filter option for employee name. This output of this screen may be used by a sales manager to assist in supervising the sales activities of individual sales representatives. The aging details reported may include a hyperlink to any comments and/or to create a comment, the company code, customer name, document number (hyperlinked to the document detail screen), document type, revenue type, doc date, sales and/or purchase order number, contract number, sales person, location code, payment term, etc. Alternatively, the aging details may include the same fields as in FIG. 4l.

FIG. 4o illustrates a past due notification template setup screen. This screen may be used by an accounting user to setup a template message. The template message may be sent by the workflow automation module if the conditions are met. The user may enter a description, a subject, and a message body, much like a form letter might be created. The user may also specify an age range for receivables—this is the triggering condition. Finally, the user may attach any of the available report types and may attach a specific document (e.g., a copy of the company policy statement on customer payment terms). The workflow automation module may apply the available templates to all accounts receivable on a regular interval (e.g., immediately after a scheduled importation of data from the ERP system) and send out a message for each customer with an accounts receivable meeting the triggering condition. In certain embodiments, other triggering conditions may be entered, for example, a threshold percentage (e.g., fifty or seventy five percent) of the customer's credit limit has been used or an average AR age is greater than some threshold number of days (e.g., 45 days).

FIG. 4p illustrates a customer management search screen. This screen may be used by an accounting user to search for customers by a set of criteria including, for example, customer number, customer name, company code, primary sales person, primary collector, class, and status. The resulting list, which may be exported to a spreadsheet, includes a number of fields. Each customer is listed with a link to a customer edit screen (e.g., a customer detail screen as illustrated in FIG. 4q below), status indicator, customer number, customer name, primary sales person, primary collector, and primary contact person.

FIG. 4q illustrates a customer edit screen. This screen may be used by an accounting user to modify the contact information for that customer or to merge that customer with another customer. The top of the screen shows the customer number, company code, and customer name. Next, the primary sales person, primary collector and class are displayed and may be modified by the accounting user. A flag may indicate that this customer has been merged with another customer. A different flag indicates that this customer is currently active.

The second portion of the screen lists the customer's locations. For each location, there may be, for example, an active status flag, a location code, a description, a type, and an address. This information may be entered by an accounting user directly this screen or it may be mastered in the ERP system and imported as read-only information in this screen. The next section displays the current credit limit, outstanding net accounts receivable, available credit, value of any outstanding orders, and available new credit (e.g., a ceiling on the amount of the credit limit). Finally, the screen displays a list of contacts with fields for entering a new contact or editing an existing one. An accounting user may enter the following information for each contact: active status, first name, last name, login name, title, phone number, email address, and fax number. Other fields may be present in certain embodiments. An accounting user may also set a month end flag if the contact is to receive an automatically generated month-end report and a primary flag if the contact is the primary contact for the customer. The month-end report may be generated by the workflow automation module and emailed to the selected customer contacts.

FIG. 4r illustrates a user management screen for creating or modifying a user login and role information. This screen may be used by an accounting manager user. The accounting manager user may enter the user's name, login information, category, email address, and active dates. The accounting manager user may then assigned a primary collector and a menu group (e.g., a role). The primary collector may be copied on all messages originated by the user and may have at least as broad of system privileges as the user so that the primary collector may step in if the user is unable to perform his duties due to absence or workload. The accounting manager user may then assign companies and customers to that user. This final step determines the scope of visibility afforded to the user.

FIG. 4s illustrates a mailbox view available to a user of the system. This view may list duplicates of messages sent via email or may be use in lieu of email with email only used to notify a user that a new message exists in the WebAging system. The top portion of the screen is a collection of available search criteria for use with the messages. A user may search the messages by, for example, sender or recipient, company, date, document number, customer purchase order number, read status, order number, error, and/or subject. The second half of the screen lists the discussion logs that match the search criteria. The list is displayed with the same fields as appear in the search portion of the screen. The subject is hyperlinked to a message detail screen.

In this manner, as an example only, a system is provided that tracks historical AR information and integrates with the business process workflow to help an organization and its customers locate documents and track their progression through the document lifecycle. Content is converged into an electronic system that enables customers, vendors and employees to efficiently act on information. This provides significant efficiency improvements by allowing users to handle a growing deluge of data and quickly respond completely to audits without heavy burdens to the business. For example, when a customer wants to resolve disputes, all of the pertinent documents resides in the web space for them to access and generate a payment.

Although the present disclosure has been described in detail, it should be understood that various changes, substitutions, and alterations can be made hereto without departing from the spirit and the scope of the invention as defined by the appended claims.

What is claimed is:

1. A computer implemented method for facilitating business communications comprising:
receiving a plurality of business transaction records from an accounting module; each business transaction record including an amount and a date;
providing a customer user interface configured to allow a first customer user, associated with a first customer, to:
search and access a first customer accessible subset of the plurality of unpaid business transaction records, the first customer accessible subset including only business transaction records associated with the first customer, and
participate in a first communication dialog, the dialog associated with one or more of the business transaction records in the first customer accessible subset; and
providing an accounting user interface configured to allow a first accounting user to:
search and access an accounting accessible subset of the plurality of unpaid business transaction records, the accounting accessible subset including the first customer accessible subset, and
participate in the first communication dialog.

2. A computer implemented method according to claim 1, further comprising:
providing a customer user interface configured to allow a second customer user, associated with a second customer, to:
search and access a second customer accessible subset of the plurality of unpaid business transaction records, the subset including only business transaction records associated with the second customer, and
participate in a communication dialog, the dialog associated with one or more business transaction records in the second customer accessible subset;
wherein the accounting user interface is further configured to allow the first accounting user to:
search and access the accounting accessible subset of the plurality of unpaid business transaction records, the accounting accessible subset including the second customer accessible subset, and
participate in the second communication dialog.

3. A computer implemented method according to claim 1, wherein the accounting accessible subset includes information associated with the business transaction records in the first customer accessible subset but not available to the first customer user.

4. A computer implemented method according to claim 1, further comprising:
providing the customer user interface further configured to allow a second customer user, associated with the first customer, to:
search and access the first customer accessible subset of the plurality of business transaction records, and
participate in the first communication dialog.

5. A computer implemented method according to claim 1, wherein the first communication dialog is initiated automatically based at least on a triggering condition.

6. A computer implemented method according to claim 5, wherein the triggering condition includes at least one of the following:
at least one business transaction record indicates an unpaid debt older than a specified age threshold;
a total unpaid debt amount, determined by aggregating an unpaid debt from each of the first customer accessible subset exceeds a specified threshold percentage of a credit limit assigned to the first customer;
a new message has been created in the communication dialog; and
a business transaction record has been disputed by the first customer user.

7. A computer implemented method according to claim 1, wherein the dialog is initiated by a user.

8. A computer implemented method according to claim 1, wherein the communication dialog includes an email message with a hyperlink to the customer user interface or the accounting user interface, the method further comprising:
receiving an information request comprising the contents of the hyperlink; and
displaying a view of the customer user interface corresponding to the communication dialog, based at least on the contents of the hyperlink.

9. A system for facilitating business communications, comprising:
an interface to an accounting module configured to retrieve a plurality of business transaction records;
a database for storing the plurality of business transaction records;
a customer user interface configured to allow a first customer user, associated with a first customer, to:
search and access a first customer accessible subset of the plurality of unpaid business transaction records, the first customer accessible subset including only business transaction records associated with the first customer, and
participate in a first communication dialog, the dialog associated with one or more of the business transaction records in the first customer accessible subset; and
an accounting user interface, configured to allow a first accounting user to:
search and access an accounting accessible subset of the plurality of unpaid business transaction records, the accounting accessible subset including the first customer accessible subset, and
participate in the first communication dialog.

10. The system of claim 9, wherein:
the customer user interface is further configured to allow a second customer user, associated with a second customer, to:
search and access a second customer accessible subset of the plurality of unpaid business transaction records, the subset including only business transaction records associated with the second customer, and
participate in a communication dialog, the dialog associated with one or more business transaction records in the second customer accessible subset;
the accounting user interface is further configured to allow the first accounting user to:
search and access the accounting accessible subset of the plurality of unpaid business transaction records, the accounting accessible subset including the second customer accessible subset, and
participate in the second communication dialog.

11. The system of claim 9, wherein the accounting accessible subset includes information associated with the business transaction records in the first customer accessible subset but not available to the first customer user.

12. The system of claim 9, wherein the customer user interface is further configured to allow a second customer user, associated with the first customer, to:
search and access the first customer accessible subset of the plurality of business transaction records, and
participate in the first communication dialog.

13. The system of claim 9, wherein the first communication dialog is initiated automatically based at least on a triggering condition.

14. The system of claim 13, wherein the triggering condition includes at least one of the following:
at least one business transaction record indicates an unpaid debt older than a specified age threshold;
a total unpaid debt amount, determined by aggregating an unpaid debt from each of the first customer accessible subset exceeds a specified threshold percentage of a credit limit assigned to the first customer;
a new message has been created in the communication dialog; and
a business transaction record has been disputed by the first customer user.

15. The system of claim 9, wherein the dialog is initiated by a user.

16. The system of claim 9, wherein the communication dialog includes an email message with a hyperlink to the customer user interface or the accounting user interface, system further configured to:
receive an information request comprising the contents of the hyperlink; and
display a view of the customer user interface corresponding to the communication dialog, based at least on the contents of the hyperlink.

17. A tangible computer-readable medium comprising software configured to:
receive a plurality of business transaction records from an accounting module; each business transaction record including an amount and a date;
provide a customer user interface configured to allow a first customer user, associated with a first customer, to:
search and access a first customer accessible subset of the plurality of unpaid business transaction records, the first customer accessible subset including only business transaction records associated with the first customer, and
participate in a first communication dialog, the dialog associated with one or more of the business transaction records in the first customer accessible subset; and
provide an accounting user interface configured to allow a first accounting user to:
search and access an accounting accessible subset of the plurality of unpaid business transaction records, the accounting accessible subset including the first customer accessible subset, and
participate in the first communication dialog.

18. The tangible computer-readable medium of claim 17, further comprising software configured to:
provide a customer user interface configured to allow a second customer user, associated with a second customer, to:
search and access a second customer accessible subset of the plurality of unpaid business transaction records, the subset including only business transaction records associated with the second customer, and
participate in a communication dialog, the dialog associated with one or more business transaction records in the second customer accessible subset;
wherein the accounting user interface is further configured to allow the first accounting user to:
search and access the accounting accessible subset of the plurality of unpaid business transaction records, the accounting accessible subset including the second customer accessible subset, and
participate in the second communication dialog.

19. The tangible computer-readable medium of claim 17, wherein the accounting accessible subset includes information associated with the business transaction records in the first customer accessible subset but not available to the first customer user.

20. The tangible computer-readable medium of claim 17, further comprising software configured to:
provide the customer user interface further configured to allow a second customer user, associated with the first customer, to:
search and access the first customer accessible subset of the plurality of business transaction records, and
participate in the first communication dialog.

21. The tangible computer-readable medium of claim 17, wherein the first communication dialog is initiated automatically based at least on a triggering condition.

22. The tangible computer-readable medium of claim 21, wherein the triggering condition includes at least one of the following:
at least one business transaction record indicates an unpaid debt older than a specified age threshold;
a total unpaid debt amount, determined by aggregating an unpaid debt from each of the first customer accessible subset exceeds a specified threshold percentage of a credit limit assigned to the first customer;
a new message has been created in the communication dialog; and
a business transaction record has been disputed by the first customer user.

23. The tangible computer-readable medium of claim 17, wherein the dialog is initiated by a user.

24. The tangible computer-readable medium of claim 17, wherein:
the communication dialog includes an email message with a hyperlink to the customer user interface or the accounting user interface; and
the software is further configured to:
receive an information request comprising the contents of the hyperlink; and
display a view of the customer user interface corresponding to the communication dialog, based at least on the contents of the hyperlink.
